(19) United States
(12) Patent Application Publication
(10) Pub. No.: US 2012/0236048 A1
(43) Pub. Date: Sep. 20, 2012

(54) LIQUID CRYSTAL DISPLAY AND CONTROLLER AND DRIVING METHOD OF PANEL THEREOF

(75) Inventors: Chun-Chin Tseng, Kaohsiung City (TW); Ying-Yuan Yang, Tainan City (TW); Shi-Wei Zhuang, Kaohsiung City (TW); Chia-Hua Yu, New Taipei City (TW)

(73) Assignee: HANNSTAR DISPLAY CORPORATION, New Taipei City (TW)

(21) Appl. No.: 13/177,515

(22) Filed: Jul. 6, 2011

(30) Foreign Application Priority Data
Mar. 15, 2011 (TW) 100108772

(51) Int. Cl. G09G 3/36; G09G 5/02

(52) U.S. Cl. 345/691; 345/690; 345/88

(57) ABSTRACT

A liquid crystal display (LCD), a controller and a driving method of a panel thereof are provided. Before the controller drives each data line, the driving polarity of the data lines is adjusted according to the display property of the sub-frame data signal. A first inversion driving method is employed for adjusting the data lines when the display property of the sub-frame data signal is a black frame, and a second inversion driving method is employed for adjusting when the display property of the sub-frame data signal is a color frame. Accordingly, power consumption can be lowered during the process of driving pixels, thereby achieving the purpose of power saving while not affecting the display quality.

### CROSS-REFERENCE TO RELATED APPLICATION

This application claims the priority benefit of Taiwan application serial no. 100108772, filed on Mar. 15, 2011. The entirety of the above-mentioned patent application is hereby incorporated by reference herein and made a part of this specification.

### BACKGROUND OF THE INVENTION

1. Field of the Invention

The invention relates generally to a planar display technology, and more particularly to a liquid crystal display, a controller and a driving method of a panel thereof.

2. Description of Related Art

A field sequential color-optically compensated bend (FSC-OCB) technique has been developed recently, in which the FSC-OSB technique does not require the division of a pixel into three sub-pixels in order to display three colors and the use of color filters is not needed. In order to achieve fast response time, high color saturation, and high brightness on a panel, the cold cathode fluorescent tubes in the backlight module of a thin film transistor (TFT) liquid crystal display (LCD) panel are changed to light emitting diodes (LEDs). The FSC-OCB technique switches the different color backlight sources of a RGB LED backlight module according to a timing scheme, and a relative light quantity of each light source is allocated by synchronously controlling the transmittance of the liquid crystal pixels during the display period of each color light source. In order to maintain the bend type in the FSC-OCB technique and to prevent alternating bright/dim image variations due to the color switches, all of the black and color backlight sources (e.g., red, green, and blue) must be switched off within a period of 1/240 sec. In other words, the switching time for each of the four colors needs to be less than 4.16 millisecond. The displayed color is then formed and detected by the residue effect of the light stimulus on the visual system. That is to say, when the switching time for each color is shorter than the minimum decipherable time period for human vision, a color mixing effect can be generated by exploiting the visual residue effect of the human eyes.

FIGS. 1 to 3 illustrate different schematic driving diagrams of a conventional timing controller for an FSC-OCB liquid crystal display (LCD) panel. In FIGS. 1 to 3, four sub-frame data signals need to be sequentially displayed within a frame period of a frame synchronous signal Vsync. For example, a black frame K_Data, a blue frame Blue_Data, a green frame Green_Data, and a red frame Red_Data are sequentially displayed. The timing controller illustrated in FIG. 1 employs an one dot inversion (i.e. 1V1H) driving method to drive the source driver of each of the data lines on the LCD panel. The timing controller illustrated in FIG. 2 employs a two dot inversion (i.e. 2V1H) driving method to drive the source driver of each of the data lines on the LCD panel. The timing controller illustrated in FIG. 3 employs a column inversion driving method to drive the source driver of each of the data lines on the LCD panel.

More specifically, among current TFT LCD panels employing the FSC-OCB technique, a fixed driving scheme is maintained within each of the frame periods of the frame synchronous signal Vsync regardless of the data signal outputted by the timing controller. The commonly used one dot or two dot inversion methods have a property of superior display quality at the cost of high power consumption. The column inversion method has lower power consumption, but displays poorer display quality. Moreover, the image rendered by unrefreshed pixels may be transmitted to the wrong eye, resulting in a cross talk phenomenon. Therefore, among all the fixed driving methods, it is difficult to achieve both power savings and superior display quality.

Accordingly, it is imperative to improve upon the current FSC-OCB technique so as to achieve power savings without affecting display quality.

### SUMMARY OF THE INVENTION

The invention provides a liquid crystal display (LCD), a controller and a driving method of a panel thereof, wherein power consumed in the process of driving pixels is lowered without affecting display quality.

The invention provides a controller for a field sequential color-optically compensated bend (FSC-OCB) LCD panel. The controller includes a data input latch and a control signal generator. When a display property of a sub-frame data signal received by the data input latch is a black frame, the control signal generator adjusts each of a plurality of data lines on the FSC-OCB LCD panel by a first inversion driving method, and when the display property of the sub-frame data signal is a color frame, the control signal generator adjusts each of the data lines on the FSC-OCB panel by a second inversion driving method that is different from the first inversion driving method.

The invention provides an LCD, including an LCD panel and a controller. When a display property of a sub-frame data signal received by the controller is a black frame, each of a plurality of data lines on the LCD panel is adjusted by a first inversion driving method, and when the display property of the sub-frame data signal is a color frame, each of the data lines on the panel is adjusted by a second inversion driving method that is different from the first inversion driving method.

The invention provides a driving method of an FSC-OCB LCD panel including the following steps: receiving an input data signal related to a sub-frame data signal and analyzing a display property of the sub-frame data signal; when the display property of the sub-frame data signal is analyzed as a black frame, adjusting each of the data lines on the FSC-OSB LCD panel by a first inversion driving method; when the display property of the sub-frame data signal is analyzed as a color frame, adjusting each of the data lines on the FSC-OSB LCD panel by a second inversion driving method that is different from the first inversion driving method.

According to an embodiment of the invention, the LCD further includes a gate driver. The gate driver is coupled between the controller and the LCD panel, and the gate driver drives each of a plurality of scan lines on the LCD panel in response to the driving control of the controller.

According to an embodiment of the invention, the LCD further includes a backlight module. The backlight module provides a backlight source required by the LCD panel.

According to an embodiment of the invention, the LCD panel is an FSC-OCB LCD panel.

According to an embodiment of the invention, the first inversion driving method is a column inversion driving method.

According to an embodiment of the invention, the second inversion driving method is a dot inversion driving method.

In summary, the controller disclosed in an embodiment of the invention adjusts the source driving of each of the data lines on the FSC-OCB LCD panel in accordance with the display property of the sub-frame data signal. Accordingly, the power consumption of the pixel driving process is lowered without affecting display quality.

However, the above descriptions and the below embodiments are only used for explanation, and they do not limit the scope of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1 to 3 illustrate different schematic driving diagrams of a conventional timing controller for an FSC-OCB LCD panel.

FIG. 4 is a circuit block diagram of a controller according to an embodiment of the invention.

FIG. 5 depicts a timing controller according to an embodiment of the invention.

FIG. 6 is a block diagram lustrating an LCD according to an embodiment of the invention.

FIGS. 7 and 8 illustrate different schematic driving diagrams of a FSC-OCB LCD panel according to an embodiment of the invention.

FIG. 9 is a flow chart illustrating a driving method of an FSC-OCB LCD panel according to an embodiment of the invention.

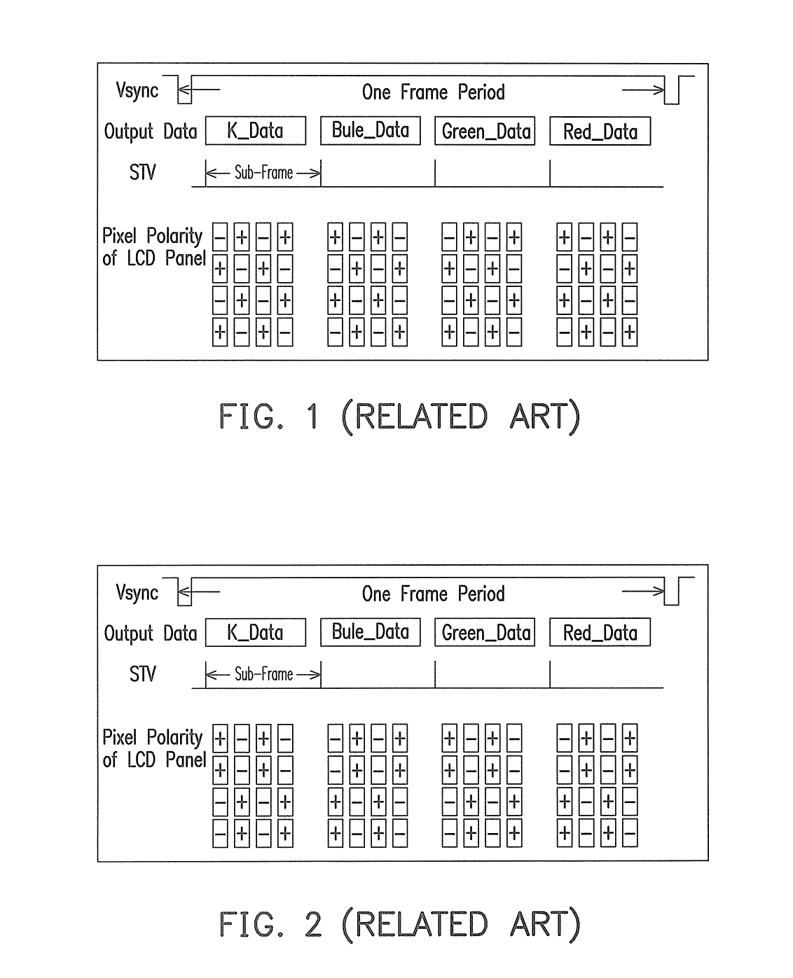

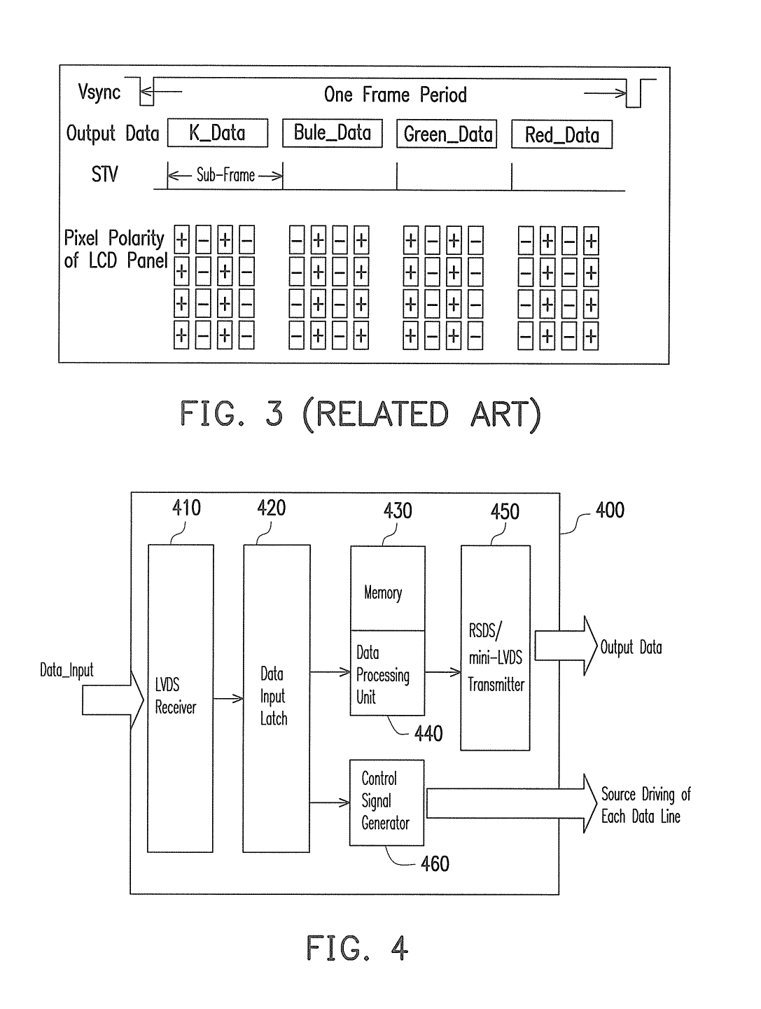

### DESCRIPTION OF EMBODIMENTS

Reference will now be made in detail to the exemplary embodiments of the invention, examples of which are illustrated in the accompanying drawings. In addition, whenever possible, identical or similar reference numbers stand for identical or similar elements in the figures and the embodiments.

FIG. 4 is a circuit block diagram of a controller according to an embodiment of the invention. A controller 400 may include a low voltage differential signaling (LVDS) receiver 410, a data input latch 420, a memory 430, a data processing unit 440, a reduced swing differential signaling/mini low voltage differential signaling (RSDS/mini-LVDS) transmitter 450, and a control signal generator 460 having an adjustable driving polarity. Moreover, the controller 400 is a timing controller and the controller 400 is preferably applied in a field sequential color-optically compensated bend (FSC-OCB) liquid crystal display (LCD) panel.

In the present embodiment, the controller 400 does not have a fixed driving method. Rather, the controller 400 has the following adjustment mechanism. The control signal generator 460 having the adjustable driving polarity is coupled to the data input latch 420. The data input latch 420 receives and latches an input data signal Data_Input. The input data signal Data_Input may include at least one sub-frame data signal. The control signal generator 460 analyzes a display property of the sub-frame data signal and accordingly adjusts the driving polarity for each of the data lines on the LCD panel. For example, the display property of the sub-frame data signal may be divided into a black frame and a color frame. The color frame may be a red frame, a blue frame, or a green frame. Since the black frame is used to maintain the bend type in the optically compensated bend (OCB) technique, the black frame does not need to be specifically displayed for the user. Accordingly, the conventional power consuming one dot or two dot driving methods are not used. Therefore, after receiving the sub-frame data signal, the control signal generator 460 may adjust the source driving of each of the data lines on the LCD panel according to the display property of the sub-frame data signal. When the sub-frame data signal is the black frame, the control signal generator 460 adjusts the source driving of each of the data lines on the LCD panel by a first inversion driving method. When the sub-frame data signal is the color frame, the control signal generator 460 adjusts the source driving of each of the data lines on the LCD panel by a second inversion driving method that is different from the first inversion driving method.

Although the above embodiment has disclosed a possible type of the driving method for the controller, it is commonly known to persons of ordinary knowledge in this art that different manufacturers may develop different designs of the driving method for the controller, and application of the invention should not be limited to this type only. In other words, as long as the controller employs the first inversion driving method to adjust each of the data lines on the panel when the sub-frame data signal is the black frame, and the controller employs the second inversion driving method that is different from the first inversion driving method to adjust each of the data lines on the panel when the sub-frame data signal is the color frame, the spirit and scope of the invention is not departed. Some other embodiments are further discussed hereinafter to allow persons of ordinary skill in the art to comprehend and embody the invention.

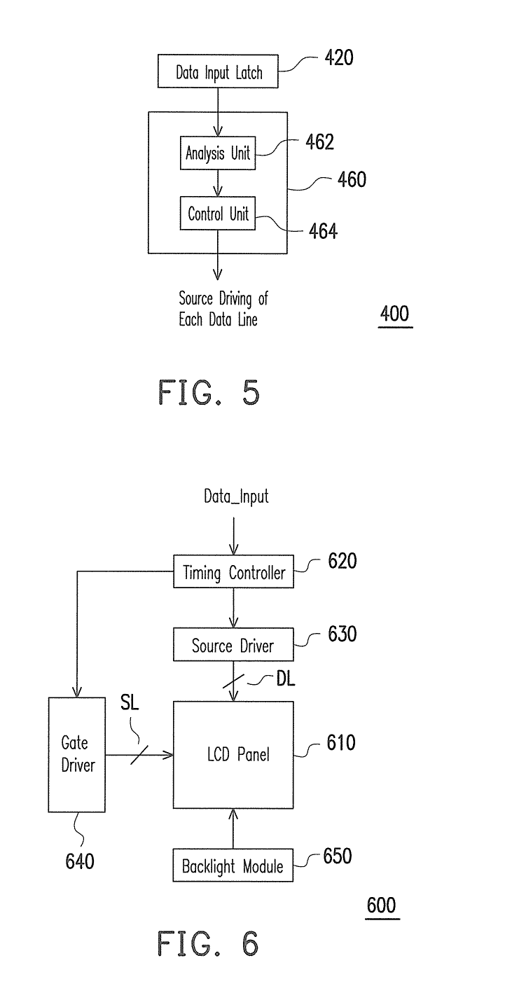

FIG. 5 depicts a timing controller according to an embodiment of the invention. Please refer to FIGS. 4 and 5 for the description below. In the present embodiment, the control signal generator 460 may include an analysis unit 462 and a control unit 464. It should be noted that the control signal generator 460 described in the present embodiment is merely one possible embodiment, and the invention is not limited thereto. For example, the analysis unit 462 may analyze the display property of the sub-frame data signal as the black frame or the color frame. Moreover, the color frame may be the red frame, the blue frame, or the green frame. The control unit 464 may adjust the source driving of each of the data lines on the LCD panel according to an analytical result of the analysis unit 462. When the analytical result is the black frame, the control unit 464 adjusts the source driving of each of the data lines on the LCD panel by the first inversion driving method. When the analytical result is the red, green, or blue frame, the control unit 464 adjusts the source driving of each of the data lines on the LCD panel by the second inversion driving method that is different from the first inversion driving method.

It should be appreciated that the first inversion driving method may be the column inversion driving method, whereas the second inversion driving method may be the one dot or the two dot inversion driving method. Therefore, the adjustment mechanism of the timing controller can achieve both power savings and superior display quality.

FIG. 6 is a block diagram illustrating an LCD according to an embodiment of the invention. Please refer to FIG. 6 for the following description. An LCD 600 may include an LCD panel 610, a timing controller 620, and a source driver 630. The source driver 630 is coupled between the timing controller 620 and the LCD panel 610. The LCD panel 610 may include a plurality of parallel scan lines SL, a plurality of vertical data lines DL, and a plurality of pixels. The timing controller 620 receives the input data signal Data_Input related to the sub-frame data signal and adjusts the source driving of each of the data lines DL on the LCD panel 610 according to the display property of each sub-frame data signal. When the display property of the sub-frame data signal is the black frame, the source driving of each of the data lines DL on the LCD panel 610 is adjusted by the first inversion driving method. When the display property of the sub-frame data signal is the color frame, the source driver 630 of each of the data lines on the LCD panel 610 is adjusted by the second inversion driving method that is different from the first inversion driving method. The timing controller 620 may be used to control the gate operation of each of the scan lines SL and the source operation of each of the data lines DL. Therefore, the source driver 630 drives each of the data lines DL on the LCD panel 610 in response to the drive control of the timing controller 620.

Moreover, the LCD 600 may include a gate driver 640 and a backlight module 650. The gate driver 640 is coupled between the timing controller 620 and the LCD panel 610. The gate driver 640 drives each of the scan lines SL on the LCD panel 610 in response to the drive control of the timing controller 620. The backlight module 650 provides a backlight source required by the LCD panel 610. For example, in a frame period, all the backlight sources may be first turned off in sequence, then red, green, and blue LED backlights are provided, although the invention is not limited thereto.

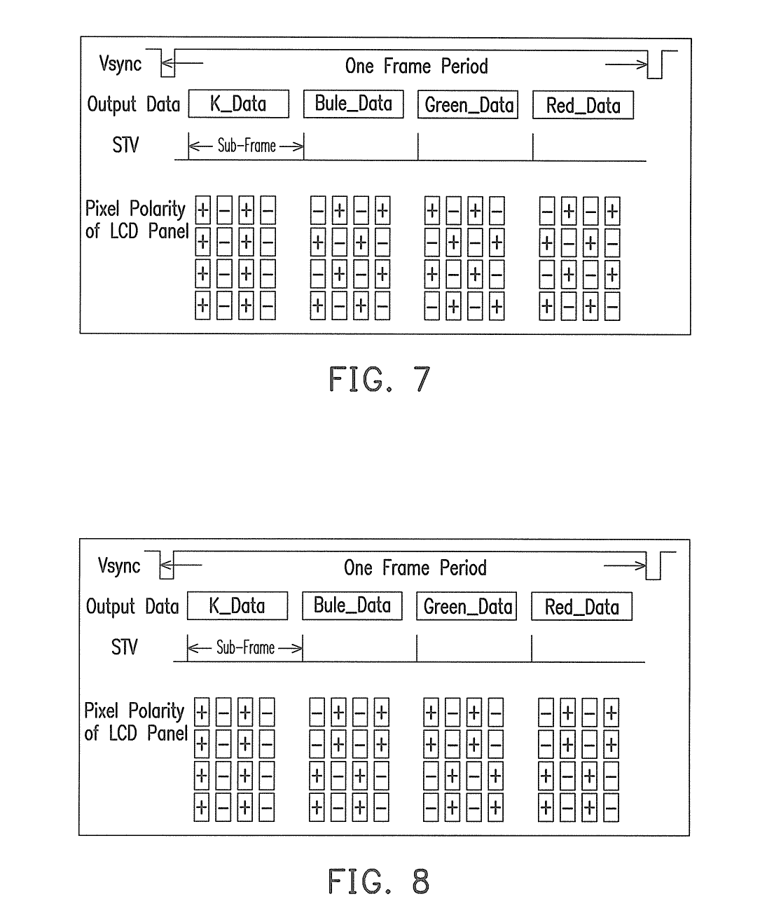

FIGS. 7 and 8 illustrate different schematic driving diagrams of an FSC-OCB LCD according to an embodiment of the invention. In FIG. 7 or 8, the LCD panel may include a plurality of parallel scan lines, a plurality of vertical data lines, and a plurality of pixels. Moreover, a driving polarity is depicted on each of the pixels. The backlight module provides a backlight source required by the LCD panel. It should be noted that the LCD panel described in the present embodiment with four scan lines, four data lines, and sixteen pixels is merely one possible embodiment, and the invention is not limited thereto. The LCD panel is coupled to the timing controller. The pixels are correspondingly coupled to the scan lines and the data lines. Since the timing controller (not shown) may be used to control the gate operation of each of the scan lines and the source operation of each of the data lines, each sub-frame data signal is outputted on the corresponding data line. The display property of each sub-frame data signal is the black frame K_Data, the blue frame Blue_Data, the green frame Green_Data, or the red frame Red_Data, and the order of the colors in each frame is not limited thereto.

A frame period of the frame synchronous signal Vsync includes four pulses of a vertical synchronous signal STV. In addition, every two pulses of the vertical synchronous signal STV is substantially equal to a switching time of a sub-frame data signal to display one color. In order to maintain the bend type in the FSC-OCB technique and to prevent alternating bright/dim image variations due to the color switches, a field sequential switching control mechanism may be performed so as to generate black and color (e.g., red, green, and blue) backlight sources.

Since the black frame K_data is used to maintain the bend type in the optically compensated bend (OCB) technique, the black frame K_data does not need to be specifically displayed for the user. Therefore, the first inversion driving method can be used for just the black frame K_data to adjust the source driver of each of the data lines. Preferably, the column inversion driving method is employed, i.e. the sources of two adjacent data lines are respectively driven to a positive driving polarity and a negative driving polarity. For example, when the sub-frame data signal is the black frame K_data, the driving polarity for the source driver of one data line is positive (+), positive (+), positive (+), positive (+), and the driving polarity for the source driver of another data line is negative (−), negative (−), negative (−), and negative (−). When the sub-frame data signal is the color frame (e.g., red, green, or blue frame), the timing controller does not use the first inversion driving method, but instead employs the second inversion driving method. For example, the second inversion driving method may be the one dot inversion (i.e. 1V1H) driving method or the two dot inversion (i.e. 2V1H) driving method.

It should be noted that without an external voltage applied, light from the backlight source passes through. That is to say, the screen is rendered white and is referred to as normally white. For a 3.8 inch FSC-OCB LCD, a measurement of the power consumption for normally white with the black frame as the test frame yields the following result, wherein the measured gray level of the pixel pattern is gray level 0 (i.e. L0):
with the conventional one dot inversion driving method: the voltage drop of L0 is 13.25 volt (V), the current is 34.14 milliampere (mA), and the power consumption is 452.36 milliwatt (mW);
with the driving method depicted in an embodiment of the invention: the voltage drop of L0 is 13.25 V, the current is 27.29 mA, and the power consumption is 361.59 mW;
comparing the two power consumption values: 452.36-361.59=90.77 mW, or substantially equal to a 20.06% saving in power consumption. Accordingly, the pixel driving process described in an embodiment of the invention lowers the power consumption by at least 20% while not affecting display quality.

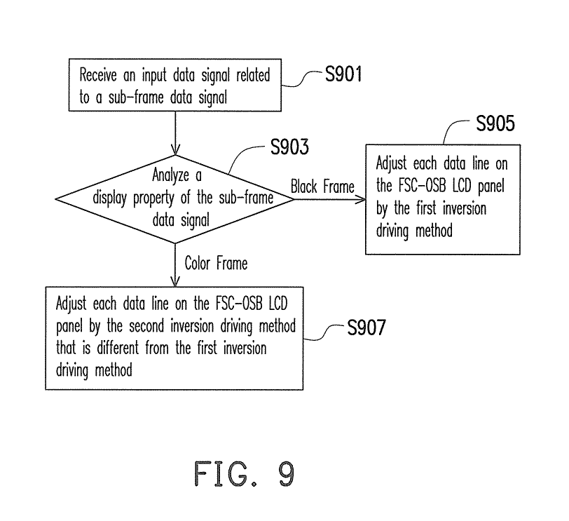

Based on the disclosure of the aforesaid embodiments, FIG. 9 is a flow chart illustrating a driving method of an FSC-OCB LCD panel according to an embodiment of the invention. Referring to FIG. 9, the driving method of the LCD panel according to the present embodiment includes: receiving an input data signal related to a sub-frame data signal (Step S901); analyzing a display property of the sub-frame data signal (Step S903); when the display property of the sub-frame data signal is analyzed as a black frame, adjusting each of the data lines on the FSC-OSB LCD panel by a first inversion driving method (Step S905); when the display property of the sub-frame data signal is analyzed as a color frame, adjusting each of the data lines on the FSC-OSB LCD panel by a second inversion driving method that is different from the first inversion driving method (Step S907).

In view of the foregoing, before the controller or the timing controller disclosed in an embodiment of the invention drives each of the data lines, the driving polarity of the data lines is adjusted in accordance with the display property of the sub-frame data signal. When the display property of the sub-frame data signal is the black frame, each of the data lines on the panel is adjusted by the first inversion driving method. Moreover, when the display property of the sub-frame data signal is the color frame, each of the data lines on the panel is adjusted by the second inversion driving method that is different from the first inversion driving method. Accordingly, the power consumption of the pixel driving process is lowered without affecting display quality.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A controller for a field sequential color-optically compensated bend (FSC-OCB) liquid crystal display (LCD) panel, comprising:
a data input latch; and
a control signal generator;
wherein when a display property of the sub-frame data signal is a black frame, the control signal generator adjusts each of a plurality of data lines on the FSC-OCB LCD panel with a first inversion driving method, and when the display property of the sub-frame data signal is a color frame, the control signal generator adjusts each of the data lines on the FSC-OCB LCD panel with a second inversion driving method that is different from the first inversion driving method.

2. The controller for the FSC-OCB LCD panel as claimed in claim 1, wherein the controller is a timing controller.

3. The controller for the FSC-OCB LCD panel as claimed in claim 1, wherein the first inversion driving method is a column inversion driving method.

4. The controller for the FSC-OCB LCD panel as claimed in claim 1, wherein the second inversion driving method is a dot inversion driving method.

5. An LCD, comprising:
an LCD panel; and
a controller;
wherein when a display property of a sub-frame data signal received by the controller is a black frame, each of a plurality of data lines on the LCD panel is adjusted by a first inversion driving method, and when the display property of the sub-frame data signal is a color frame, each of the data lines on the panel is adjusted by a second inversion driving method that is different from the first inversion driving method.

6. The LCD as claimed in claim 5, wherein the controller is a timing controller.

7. The LCD as claimed in claim 5, further comprising:
a gate driver coupled between the controller and the LCD panel, the gate driver driving each of a plurality of scan lines on the LCD panel in response to the drive control of the controller.

8. The LCD as claimed in claim 5, further comprising:
a backlight module for providing a backlight source required by the LCD panel.

9. The LCD as claimed in claim 5, wherein the LCD panel is an FSC-OCB LCD panel.

10. The LCD as claimed in claim 5, wherein the first inversion driving method is a column inversion driving method.

11. The LCD as claimed in claim 5, wherein the second inversion driving method is a dot inversion driving method.

12. A driving method of an FSC-OCB LCD panel, comprising:
receiving an input data signal related to a sub-frame data signal and analyzing a display property of the sub-frame data signal; and
when the display property of a sub-frame data signal is analyzed as a black frame, each of a plurality of data lines on the FSC-OCB LCD panel is adjusted by a first inversion driving method, and when the display property of the sub-frame data signal is analyzed as a color frame, each of the data lines on the FSC-OCB panel is adjusted by a second inversion driving method that is different from the first inversion driving method.

13. The driving method of the FSC-OCB LCD panel as claimed in claim 12, wherein the first inversion driving method is a column inversion driving method.

14. The driving method of the FSC-OCB LCD panel as claimed in claim 12, wherein the second inversion driving method is a dot inversion driving method.
